(19) United States
(12) Patent Application Publication
(10) Pub. No.: US 2026/0104029 A1
(43) Pub. Date: Apr. 16, 2026

(54) Clementine Green Energy Electrical Generator

(71) Applicant: Sean WIlliam Quigley, Westland, MI (US)

(72) Inventor: Sean WIlliam Quigley, Westland, MI (US)

(21) Appl. No.: 18/914,122

(22) Filed: Oct. 12, 2024

(51) Int. Cl. F03B 17/00

(52) U.S. Cl. CPC F03B 17/005; F05B 2220/708

(57) ABSTRACT

This system is a construction of readily available proven parts being assembled to allow someone who uses it to generate electricity to power the application of their choosing. The assembly of parts is designed to work in conjunction to flow water through the turbine to generate enough electricity that is then passed on to the battery bank so said battery bank can then supply the needs of the pump and excess energy can be used by the application.

### CROSS-REFERENCE TO RELATED APPLICATIONS

Not Applicable

### FEDERALLY SPONSORED RESEARCH AND DEVELOPMENT

Not Applicable

### JOINT RESEARCH AGREEMENT

Not Applicable

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### PRIOR ART

See common electrical generation and transmission systems.

### BACKGROUND OF THE INVENTION

It is common understanding that the generation and transference of electricity is inefficient, expensive for the consumer, and depending on the source of energy used, harmful to the planet. This generation device will nullify all the downsides of the current system of electrification.

### SUMMARY OF THE INVENTION

This generation device is a grid-independent closed loop hydro-electric generator.

### BRIEF DESCRIPTION OF DRAWINGS

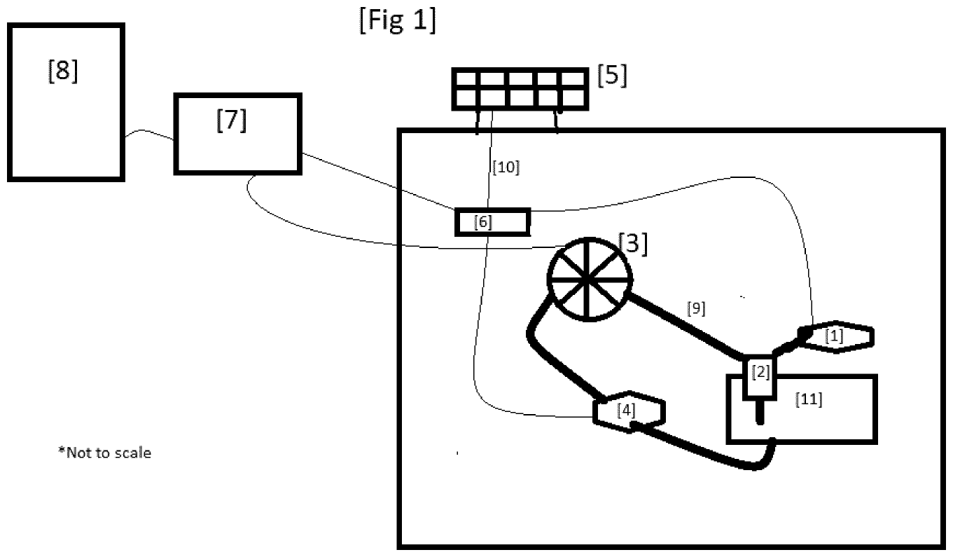

The drawing FIG. 1 contained in this application will show the parts of the system required for successful operation.

1—Pump
2—Eductor
3—Turbine
4—Booster Pump
5—Solar Panel
6—Battery Bank
7—Inverter
8—Application
9—Piping
10—Electrical Power Cordage
11—Reservoir

### DETAILED DESCRIPTION OF THE INVENTION

This description refers to FIG. 1. This system utilizes a pump [1] that draws from the reservoir [11] and feeds into the eductor [2]. The power of this flow draws more water via the eductor to the stream matching the need of the turbine [3] to produce the level of electricity required by the application. Once the water passes through the turbine it is returned to the reservoir via the piping [9] with a booster pump [4] for applications that require one. The electricity generated by the flow of water goes to an inverter via electric power cordage [10] to charge the battery bank [6]. From the battery bank the electricity is then distributed via power cordage to the pump, with the surplus being used by the application [8] needing energy. The solar panel [5] is provided should system consumption outstrip demand. The size of all elements of this device is dependent on energy required.

1. This generation system will allow those who employ it to free themselves from both fossil fuel-based generation systems and grid supplied power.
